(19) United States
(12) Patent Application Publication
(10) Pub. No.: US 2005/0182566 A1
(43) Pub. Date: Aug. 18, 2005

(54) Method and apparatus for determining filtrate contamination from density measurements

(75) Inventor: Rocco DiFoggio, Houston, TX (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated, Houston, TX (US)

(21) Appl. No.: 11/036,674

(22) Filed: Jan. 14, 2005

Related U.S. Application Data
(60) Provisional application No. 60/536,371, filed on Jan. 14, 2004.

(51) Int. Cl. G01V 3/18

(52) U.S. Cl. 702/11

(57) ABSTRACT

The present invention provides a downhole method and apparatus to determine the percentage of oil based mud or water based mud filtrate contamination in a formation fluid sample. The present invention determines the percentage of filtrate contamination in a sample comprised of a mixture of crude oil and an oil based mud filtrate or of formation brine and a water based mud filtrate. The filtrate contamination percentage is determined from a relationship between the densities of uncontaminated formation fluid and filtrate. Filtrate may oil based or water based mud. The density of formation fluid is determined from a series of high precision pressure measurements of formation fluid at a plurality of depths in a hydrocarbon producing well. The density of filtrate is provided by downhole measurements with a flexural mechanical resonator or by measurements made downhole or at the surface.

### CROSS REFERENCE TO RELATED PATENT APPLICATIONS

This patent application claims priority from United States Provisional patent application Ser. No. 60/536,371, filed on Jan. 14, 2004 entitled Method and Apparatus for Determining Oil Based Mud Filtrate Contamination from High Precision Density Measurements, by Rocco DiFoggio.

### BACKGROUND OF THE INVENTION

1. Field of the Invention

The present invention relates to the field of downhole formation fluid sample analysis in hydrocarbon producing wells. More particularly, the present invention relates to a method and apparatus for determining the percentage of filtrate contamination in a formation fluid sample from a relationship between formation fluid density, filtrate density and sample density.

2. Background of the Related Art

In wellbore exploration, drilling mud such as oil-based mud and synthetic-based mud types are used. The filtrates from these mud types generally invade the formation through the borehole wall. This filtrate must be removed as well as it can be removed from the formation by pumping fluid and filtrate from the formation in order to access the “pure”formation fluids after filtrate has been pumped out. Open hole sampling is an effective way to acquire representative reservoir fluids. Open hole sample acquisition allows determination of critical information for assessing the economic value of oil and gas reserves. In addition, optimal hydrocarbon production strategies can be designed to handle these complex formation fluids. In open hole sampling, initially, the flow from the formation contains considerable filtrate, but as this filtrate is pumped or drained from the formation, the flow increasingly becomes richer in formation fluid. That is, the sampled fluid flow from the formation contains a higher percentage of formation fluid and less filtrate as pumping continues.

It is well known that formation fluid being pumped from a wellbore undergoes this clean-up process in which the purity of the sample increases over time as filtrate is gradually removed from the formation and less filtrate appears in the sample. When extracting fluids from a formation, it is desirable to quantify the cleanup progress, that is, the degree contamination from filtrate in real time. If it is known that there is too much filtrate contamination in the sample (more than about 5 or 10%), it is seldom feasible to collect the formation fluid sample in a sample tank until the contamination level drops to an acceptable level. Thus, there is a need for determining the percentage of filtrate contamination in a sample.

There is also considerable interest in analyzing formation fluids density downhole at reservoir conditions of extreme temperature and pressure during formation sampling, production or drilling. Numerous technologies have been employed toward the end of measuring density and viscosity of liquids downhole. U.S. Pat. No. 6,182,499 discloses a system and method for characterization of materials and combinatorial libraries with mechanical oscillators. U.S. Pat. No. 5,734,098 discloses a method for monitoring and controlling chemical treatment of petroleum, petrochemical and processes with on-line quartz crystal microbalance sensors. The '098 method utilizes thickness shear mode (TSM) resonators, which simultaneously measure mass deposition and fluid properties such as viscosity and or density of a fluid. U.S. Pat. No. 6,176,323 (the '323 patent) discloses drilling systems with sensors for determining properties of drilling fluid downhole. The '323 patent discloses a plurality of pressure sensors at different depths to determine the fluid gradient.

U.S. Pat. No. 5,741,962 (the '962 patent) discloses a method and apparatus for analyzing a formation fluid using acoustic measurements. The '962 patent device acoustically determines density and compressibility from acoustic impedance and sound speed. U.S. Pat. No. 5,622,223 (the '223 patent) discloses a method and apparatus for formation fluid samples utilizing differential pressure measurements. The '223 patent discloses an apparatus that provides two pressure gauges at different depths to determine density from a fluid pressure gradient. U.S. Pat. No. 5,006,845 uses differential fluid pressure at two depths to determine fluid density. U.S. Pat. No. 5,361,632 discloses a method and apparatus for determining multiphase hold up fractions using a gradiometer and a densiometer to provide a pressure gradient to determine fluid density. U.S. Pat. No. 5,204,529 discloses a method and apparatus for measuring borehole fluid density, formation density and or borehole diameter using back-scattered gamma radiation to determine fluid density.

It is well known that it is possible to obtain the true formation fluid density, substantially unaffected by near-wellbore filtrate contamination, by measuring the formation fluid's pressure at a series of depths, determining the pressure gradient, and dividing this gradient by the acceleration of gravity. The reason is that a very large expanse of fluid around the wellbore (perhaps an acre or more around the wellbore) contributes to the formation fluid's pressure. Therefore, a few inches of near-wellbore filtrate contamination by some fluid (i.e., filtrate contamination), which has a different density than the formation fluid, has a negligible effect on the fluid pressure.

Flexural mechanical resonators have used in the laboratory for rapid characterization of large numbers of fluid samples. See L. F. Matsiev (Symyx), Application of Flexural Mechanical Resonator to High Throughput Liquid Characterization, 2000 IEEE International Ultrasonics Symposium, Oct. 22-25, 2000 San Juan, Puerto Rico, incorporated herein by reference in its entirety; L. F. Matsiev (Symyx), Application of Flexural Mechanical Resonator to High Throughput Liquid Characterization, 1999 IEEE International Ultrasonics Symposium, Oct. 17-20, Lake Tahoe, Nev., incorporated herein by reference in its entirety; L. F. Matsiev (Symyx), Application of Flexural Mechanical Resonator to High Throughput Liquid Characterization, 1998 IEEE International Ultrasonics Symposium, Oct. 5-8, 1998, Sendai, Miyagi, Japan, incorporated herein by reference in its entirety.

At present, the inventor is not aware of any known direct methodology for quantifying the percentage of oil based mud filtrate contamination in samples of crude oil that are collected with a wireline formation tester or in determining the water based mud filtrate contamination in samples of formation brine collected with a wireline formation tester. Thus, there is a need for a method and apparatus for directly determining the percentage of oil based mud filtrate contamination in crude oil samples or the percentage of water based mud filtrate contamination in brine samples collected in a downhole environment.

### SUMMARY OF THE INVENTION

The present invention provides a downhole system, apparatus and method to determine the percentage of oil-based or water-based mud filtrate contamination in a formation fluid sample. The present invention determines the percentage of filtrate contamination in a sample comprised of a mixture of formation fluid (crude oil or brine) and filtrate. The filtrate percentage is determined from a relationship between the densities of the contaminated formation fluid sample, the density of the formation fluid and the density of filtrate. Filtrate is typically oleic (from oil-based mud) or aqueous (from water-based mud). The density of formation fluid is determined from a series of high precision pressure measurements of formation fluid at a plurality of depths in a hydrocarbon producing well. The present invention provides a function that performs a least squares fit of the pressure to depth relationship. It is well known that pressure, P=ρgh, thus, the best-fit slope is the density ρ, times the acceleration of gravity, g. The present invention additionally provides a method and apparatus for determining sample cleanup from a leveling off in the reduction of the percentage of filtrate contamination in a fluid removed from a formation during continuous pumping.

The density of the oil based mud filtrate should be very close to the density of the original base oil at the same temperature and pressure, thus, the filtrate density is estimated using a density table at various pressures and temperatures. Alternatively, the filtrate density can be measured on site. In another alternative embodiment, since the majority of the fluid flowing into a sampling tool at the start of pumping or sampling is filtrate, it is possible to use initial density measurements as the estimated filtrate density.

The percentage of filtrate contamination, f is equal is related to ρ_{F} (Filtrate density), ρ_{O} (density of Original formation fluid), and ρ_{M} (density of a Mixture of filtrate and original formation fluid), as follows:
ρ_{M}=fρ_{F}+(1−f)ρ_{O}
where, f=the fraction of filtrate contamination in a mixture of the orginal formation fluid and a filtrate, thus f=(ρ_{M}−ρ_{O})/(ρ_{F}−ρ_{O}) and therefore the percentage of contamination is equal to 100 times f, which is the fraction of filtrate contamination in the mixture. In this invention, the filtrate is miscible with the original formation fluid. When collecting a crude oil sample, this invention is applicable to a formation fluid comprised of crude oil contaminated by an oil-based mud filtrate. When collecting a formation brine sample, this invention is applicable to a formation fluid comprised of brine contaminated by a water-based mud filtrate.

In one aspect of the invention, a downhole tool for determining the filtrate contamination percentage for a formation fluid sample is provided comprising a tool deployed in a well bore formed in a formation. The tool communicates with a quantity of downhole fluid. A pressure measuring device performs a series of pressure measurements of the downhole fluid at depth to determine the density of the original formation fluid. A density measuring device, such as a mechanical resonator is attached to the tool immersed in the recovered fluid sample. A controller actuates the mechanical resonator and a monitor receives a response from the mechanical resonator in response to the actuation of the mechanical resonator in the fluid. A processor is provided for determining a density of a fluid sample from the response of the mechanical resonator. In another aspect of the invention a tool is provided wherein the densities of the contaminated fluid sample, the original formation fluid and the filtrate are used to determine the percentage of the filtrate contamination for sample.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For a detailed understanding of the present invention, references should be made to the following detailed description of an embodiment, taken in conjunction with the accompanying drawings, in which like elements have been given like numerals, wherein:

FIG. 1 is an illustration of a model for an equivalent circuit for a thickness-shear-mode (TSM) resonator complex impedance in a liquid environment;

FIG. 2 is an illustration of resonator connections in an embodiment;

FIGS. 3A and 3B illustrate acquired data on the frequency response of a 32.768 kHz tuning fork resonator for a variety of common organic solvents generating a family of curves;

FIG. 4A and 4B illustrate values for ΔL and ΔZ plotted versus the solvent density and square root of the solvent viscosity density product, respectively;

FIG. 5 is a schematic diagram of an embodiment of the present invention deployed on a wireline in a downhole environment;

FIG. 6 is a schematic diagram of an embodiment of the present invention deployed on a drill string in a monitoring while drilling environment;

FIG. 7 is a schematic diagram of an embodiment of the present invention deployed on flexible tubing in a downhole environment;

FIG. 8 is a schematic diagram of an embodiment of the present invention as deployed in a wireline downhole environment showing a cross section of a wireline formation tester tool;

FIG. 9A is a schematic diagram of an embodiment of the present invention illustrating a tuning fork as deployed in a fluid flow pipe;

FIG. 9B is a schematic diagram of an alternative embodiment of the present invention illustrating a tuning fork as deployed in a recess formed in fluid flow pipe to remove the tuning fork from the majority of the turbulence of the fluid flowing in the flow path;

FIG. 10 illustrates an example of the present invention shown as a process diagram for obtaining filtrate contamination percentage;

FIG. 11 illustrates an example of measuring density of a crude oil in an embodiment of the invention;

FIG. 12 illustrates an example of the steps to measure density of filtrate in an embodiment of the invention;

FIG. 13 illustrates an alternative example of the steps to determine filtrate density in an embodiment of the invention;

FIG. 14 illustrates another alternative example to determine filtrate density in an embodiment of the invention; and

FIG. 15 illustrates another example of the present invention to determine density of filtrate in an embodiment of the invention is shown.

### DETAILED DESCRIPTION OF THE INVENTION

The present invention provides a downhole method and apparatus to determine the percentage of mud filtrate contamination in a formation fluid sample. The present invention determines the percentage of filtrate contamination in a sample comprised of a mixture of crude oil and oil based mud filtrate or of formation brine and water based mud filtrate. The filtrate contamination percentage is determined from a relationship between the density of the filtrate-contaminated sample, the density of the pure formation fluid, and the density of the filtrate.

The density of formation fluid is determined from a series of high precision pressure measurements of formation fluid at a plurality of depths in a hydrocarbon producing well. The present invention provides a function that performs a least squares fit of the pressure to depth. As is well known, P=ρgh, thus the best-fit slope is the density ρ, times the acceleration of gravity, g. The present invention additionally provides a method and apparatus for determining sample cleanup from a leveling off in the reduction of the percentage of filtrate contamination with continued pumping.

The present invention provides a downhole method and apparatus using a mechanical resonator, preferably, a tuning fork to provide real-time direct measurements and estimates of the density for formation fluid and filtrate in a hydrocarbon producing well. The present invention additionally provides a method and apparatus for monitoring formation fluid or sample cleanup from a leveling off of the density over time as the fluid under investigation transitions from contaminated to substantially pure formation fluid. Currently, there is no method or apparatus for directly determining the fraction of filtrate contamination in a fluid sample in the downhole environment, thus, the present invention provides measurement capability that is currently unavailable in the oil services industry.

The Matsiev/Symyx references noted above, describe the application of flexural mechanical resonators such as tuning forks, benders, etc. to liquid characterization for measuring density of a fluid. Additional complex electrical impedance produced by a liquid environment to such resonators is also described. Matsiev shows that this additional impedance can be represented by the sum of two terms: one that is proportional to liquid density and a second one that is proportional to the square root the of viscosity density product. This Matsiev/Symyx impedance model is universally applicable to any resonator type that directly displaces liquid and has size much smaller than the acoustic wavelength in a liquid at its operation frequency. Using this Matsiev/Symyx model it is possible to separately extract liquid viscosity and density values from the flexural resonator frequency response, while conventional TSM resonators can measure only the viscosity density product.

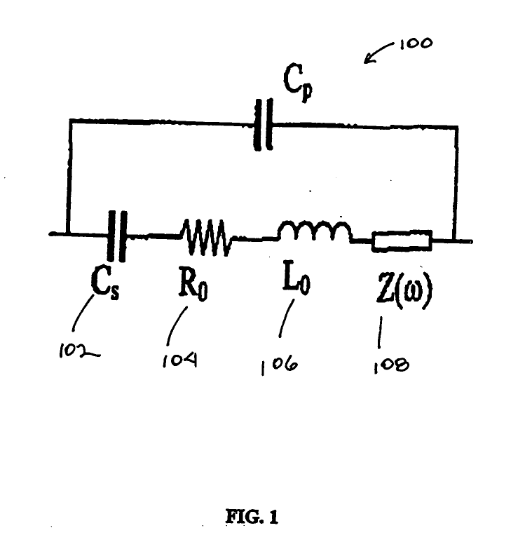

Thickness-shear mode (TSM) quartz resonators have been applied to the determination of mechanical properties of liquids for several decades. Oscillation of the TSM resonator surface exposed to liquid along a crystal-liquid interface produces a decaying viscous shear wave in liquid. A simple relationship between the impedance of the TSM resonator change caused by contact with a liquid and the viscosity density product of liquid has been derived using a simple one-dimensional mathematical model and is supported experimentally. TSM resonator complex impedance in a liquid environment can be represented by equivalent circuit shown on FIG. 1.

Equivalent parameters Cₛ, 100 Rₒ, 102 and L₀ 106 represent respectively mechanical compliance, loss and inertia of the resonator in vacuum. Additional impedance Z(ω) 108 produced by surrounding liquid is given by (ωρη)^{1/2} (1+i) per unit interface area, where ω is the operation frequency, ρ is the liquid density, η is the viscosity of the liquid. Parallel capacitance C_{ρ}, an electrical capacitance measured between the resonator electrodes, is also affected by electrical properties of surrounding liquid.

Low-frequency piezoelectric resonators such as bar benders, disk benders, cantilevers, tuning forks, micro-machined membrane and torsion resonators are provided as flexural mechanical resonators. A wide variety of such resonators with operation frequency from hundreds of hertz up to a few MHz are commercially available.

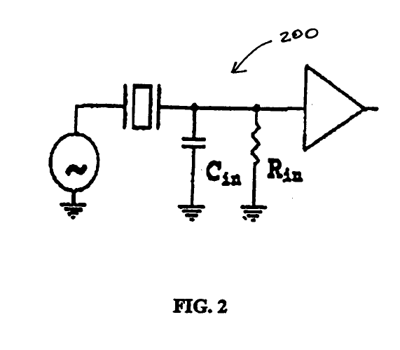

There are a variety of ways to measure resonator response in a liquid environment. An HP8751A network analyzer is one of many suitable generators that can be used to generate sweep frequencies and measure resonator response when the resonator was exposed to a variety of organic solvents. The equivalent impedance of tuning forks is quite high, so the use of high impedance probe is desirable. In one embodiment an exciter circuit 200 is provide and the resonator is connected as shown on FIG. 2.

The resonator impedance and probe amplifier known input impedance form a frequency dependent voltage divider. The frequency dependence of the normalized absolute value of the probe input voltage was recorded while resonator was submerged in various organic solvents.

The equivalent circuit from FIG. 1 also describes the impedance of the flexural resonator with a modification for the additional impedance Z(ω). Despite the complexity of such a problem it is possible to state that the flow is in effect a viscous flow of an incompressible liquid. Oscillation velocity at the interfaces of an oscillating flexural resonator does have a component normal to the interface, so some compression should occur. At the same time, the size of flexural resonators is much less than a wavelength of the compression wave in surrounding liquid at an operational frequency. Therefore low-frequency resonators are, in general, quite ineffective exciters of compression waves regardless of the oscillation mode.

For viscous incompressible flow the vorticity of the velocity field decays with the distance from the oscillating body in the same manner as the velocity decays with the distance from TSM resonator. This means that some component of the additional impedance of a flexural resonator should be proportional to (ωρη)^{1/2} (1+i) as is the case for the TSM resonator, with some unknown coefficient or geometry factor, which itself depends upon the resonator geometry and oscillation mode.

In contrast to TSM resonators flexural resonators directly displace liquid. The virtual hydrodynamic mass attached to a body moving in a liquid due to direct displacement depends only on the body geometry and liquid density. It should manifest itself as an additional inductive component of the equivalent impedance proportional to liquid density.

That additional impedance of a flexural resonator is represented by the following relationship: Z(ω)=Aiωρ+B\sqrt{ωρη}(1+i), where ω is the operation frequency, ρ is the liquid density, η is the liquid viscosity, A and B are the geometry factors that depend only on the resonator geometry and mode of oscillation. Alternatively, this relationship can be rewritten as: Z(ω)=iωΔL+ΔZ\sqrt{ω}(1+i), where ΔL=Aρ and ΔAZ=B\sqrt{ρη} are frequency independent parameters, which can be easily calculated by fitting experimental data using, for example, the least squares method.

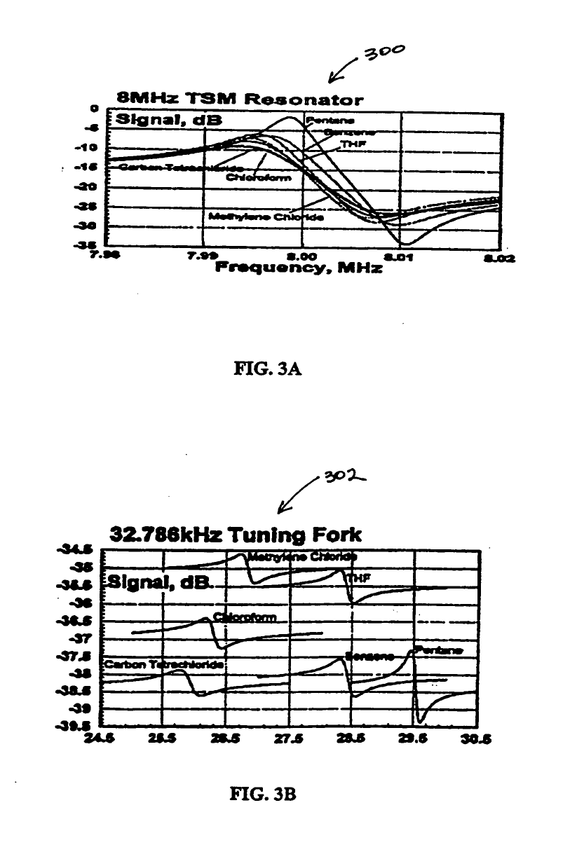

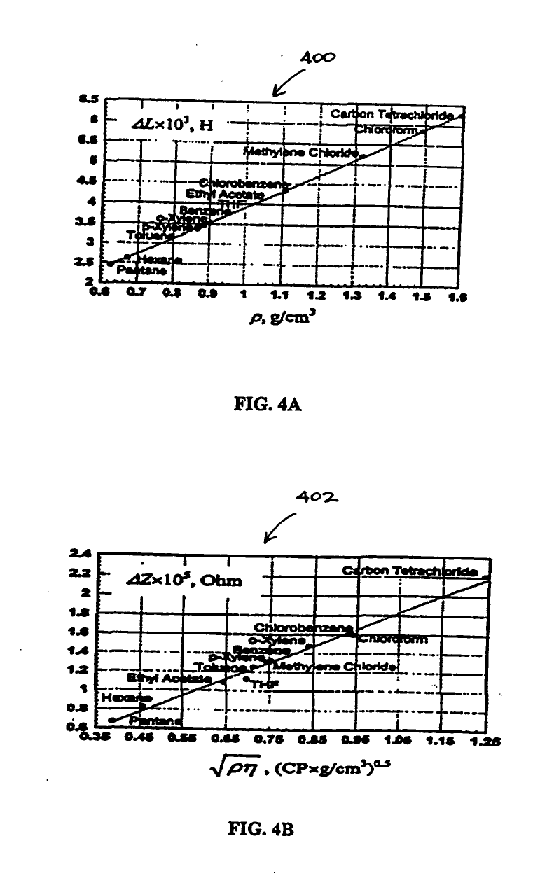

Turning now to FIGS. 3A and 3B, acquired data 300, 302 on the frequency response of the 32.768 kHz tuning fork resonator for a variety of common organic solvents generating a family of curves, are shown in FIGS. 3A and 3B. The data shown in FIGS. 3A, 3B, 4A and 4B was acquired by Symyx. Values for ΔL and ΔZ were determined by fitting the frequency response data to the proposed mathematical model. In general the model was found to be in excellent agreement with the data. The residuals could be entirely attributed to electronic noise rather than the difference between the model and the data. Turning now to FIG. 4, values for ΔL and ΔZ plotted versus the solvent density and square root of the solvent viscosity density product, respectively, are shown in FIG. 4. Density and viscosity values were taken from literature (CRC, Aldrich). The standard deviation for ordinate values on both FIG. 3 and FIG. 4 plots calculated by fitting software is less than the size of the data point marker.

In practice, a low-frequency response is usually more interesting. For example, most lubricants work under low-frequency shear stress. Low-frequency piezoelectric resonators such as bar benders, disk benders, cantilevers, tuning forks, micro-machined membrane and torsion resonators can be used. A wide variety of such resonators with operation frequency from hundreds of hertz up to few MHz are commercially available.

Flexural mechanical resonators respond to the both the density and viscosity of a fluid into which they are immersed. As described in the Matsiev/Symyx references cited above, Symyx Technologies Incorporated of Santa Clara, Calif. has developed a model for a miniature tuning fork resonator, which enables separate determination of density and viscosity of fluid, rather than merely the product of these two properties. In prior known solutions, TSM resonators could only determine the product of density and viscosity and thus viscosity or density could not be independently determined. The present invention provides a tuning fork or flexural resonator, which is excited, monitored and process to separately determine not only the density and viscosity of a fluid, but also the dielectric constant of a fluid.

The present exemplary resonator tuning forks are very small, approximately 2 mm×5 mm. These tuning forks are inexpensive and have no macroscopically moving parts. Moreover, the resonator tuning forks can operate at elevated temperature and pressure. The tuning forks enable a more accurate method of determining viscosity and other fluid properties downhole than other known methods. The tuning forks are provided by Symyx and are made of quartz with silver or gold electrodes. Symyx states that the typical accuracy for determination is ±0.01% for density, ±1.0% for viscosity, and ±0.02% for dielectric constant. In an exemplary embodiment, the electrodes are connected to wires. The connections between the wires and electrodes are covered with epoxy to prevent corrosion of the connections to the electrodes.

A common method for determining true formation fluid density is determination of the pressure gradient. Density is proportional to the slope of a plot of pressure versus depth over a depth interval of 50-150 feet. Generally, the tool is moved from point to point in the well so that the same pressure gauge is used to make all the pressure readings.

U.S. Pat. No. 5,622,223 (the '223 patent) discloses the use of differential pressure gauges spaced closely together so that to fit within the length of a tool. Thus, this design does not require relocation of the tool to make a pressure gradient measurement. It is not clear how the two '223 pressure gauges are inter-calibrated. It is hard to keep two different pressure gauges inter-calibrated within a few tenths of a PSI at high temperatures and pressures. Inter-calibration could be attempted utilizing the known density of the drilling mud and its pressure gradient as the calibrator. A density measurement can also be made from the acoustic reflection intensity at the interface of an unknown fluid and a known solid as disclosed in U.S. Pat. No. 5,741,962 (the '962 patent). Density can also be measured using gamma rays as disclosed in U.S. Pat. No. 5,204,529 (the '529 patent).

The measurement of fluid viscosity downhole can be estimated from the well-known inverse relationship between Nuclear Magnetic Resonance (NMR) decay time and viscosity. Alternatively, any differential pressure gauge sensitive enough to determine density from a short-spacing (10-20 feet) pressure gradient should be sufficiently sensitive to determine viscosity from the pressure drop versus flow rate in a wireline formation tester.

The flexural mechanical oscillator generates a signal which is utilized to determine formation fluid properties and transmits the signal to a processor or intelligent completion system (ICE) 30 for receiving, storing and processing the signal or combination of signals.

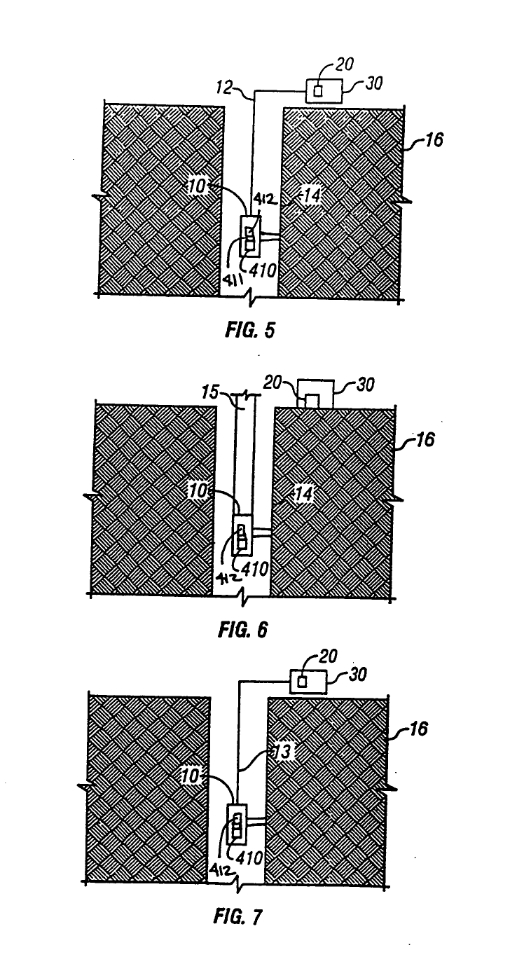

FIG. 5 is a schematic diagram of an embodiment of the present invention deployed on a wireline in a downhole environment. As shown in FIG. 5, a downhole tool 10 containing a mechanical resonator 410, processor 411 and pressure measurement device 412 is deployed in a borehole 14. The borehole is formed in formation 16. Tool 10 is deployed via a wireline 12. Data from the tool 10 is communicated to the surface to a computer processor 20 with memory inside of an intelligent completion system 30. FIG. 6 is a schematic diagram of an embodiment of the present invention deployed on a drill string 15 in a monitoring while drilling environment. FIG. 7 is a schematic diagram of an embodiment of the present invention deployed on a flexible tubing 13 in a downhole environment.

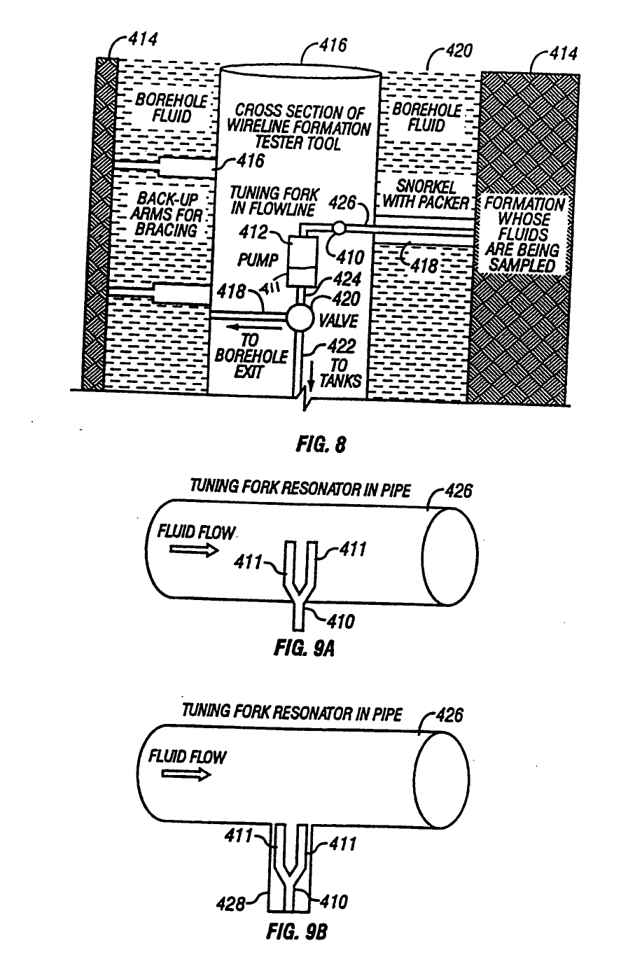

FIG. 8 is a schematic diagram of an embodiment of the present invention as deployed in a wireline downhole environment showing a cross section of a wireline formation tester tool. As shown in FIG. 8, tool 416 is deployed in a borehole 420 filled with borehole fluid. The tool 416 is positioned in the borehole by backup support arms 416. A packer with a snorkel 418 contacts the borehole wall for extracting formation fluid from the formation 414. Tool 416 contains tuning fork 410 disposed in flowline 426. Any type of flexural mechanical oscillator that can make high precision density measurements when deployed downhole in the tool is suitable for use in the present invention. Examples of well known high precision density devices, are, but not limited to a Meller-Paar vibration U tube and a mechanical resonator. The mechanical resonator, shown in FIG. 8 illustrated as a tuning fork is excited by an electric current applied to its electrodes and monitored to determine density, viscosity and dielectric coefficient of the formation fluid. Numerous mechanical resonators are suitable for use for high density measurements for use with the present invention. The electronics for exciting and monitoring the flexural mechanical resonator as shown in the Matsiev references are housed in the tool 10. Pump 412 pumps formation fluid from formation 414 into flowline 426. Formation fluid travels through flow line 424 in into valve 420 which directs the formation fluid to line 422 to save the fluid in sample tanks or to line 418 where the formation fluid exits to the borehole. The tuning fork is excited and its response in the presence of a formation fluid sample is utilized to determine fluid density, viscosity and dielectric coefficient while fluid is pumped by pump 412 or while the fluid is static, that is, when pump 412 is stopped.

FIG. 9A is a schematic diagram of an embodiment of the present invention illustrating a tuning fork 412 with tines 411 deployed in a fluid flow pipe 426. FIG. 9B is an alternative embodiment of the present invention in which the turning fork is recessed out of the flow pipe into a recess, cavity or clean out 428. The location of the tuning fork in the recess, out of the flow pipe in the recess helps prevent abrasion or damage to the tuning fork from turbulence or sand and other debris present in the formation fluid sample as the formation fluid flows in the flow pipe.

As shown in FIG. 8, the present invention can be utilized in flowing fluid, as when a sample of well bore fluid or formation fluid is pumped through the tool and into the well bore. In this scenario, where fluid is pumped through the tool, the mechanical resonator, which can be a bar bender, disk bender, cantilever, tuning fork, micro-machined membrane or torsion resonator, is immersed in the flowing fluid and used to determine the density, viscosity and dielectric constant for the fluid flowing in the tool.

In one embodiment, baffles are provided in the flow path to protect the mechanical resonator from the physical stress of the flowing fluid. A porous, sintered metal cap or a screen can also be used to cover the mechanical oscillator and protect it from pressure pulses and particles of sand or other solids. As shown in FIG. 9B, in an alternative embodiment, the tuning fork is placed out of the flow path in a recess 428 to protect the tuning fork from harm from the turbulence and debris associated with the fluid sample flowing in the flow pipe.

In a second scenario of operation the fluid sample flowing in the tool is stopped from flowing by stopping the pump 412 while the mechanical resonator is immersed in the fluid and used to determine the density, viscosity and dielectric constant for the static fluid trapped in the tool. The operator, located at the surface and having access to over ride the processor/ICE 30 may make his own decisions and issue commands concerning well completion based on the measurements provided by the present invention. The present invention may also provide data during production logging to determine the nature of fluid coming through a perforation in the well bore, for example, the filtrate and oil percentages.

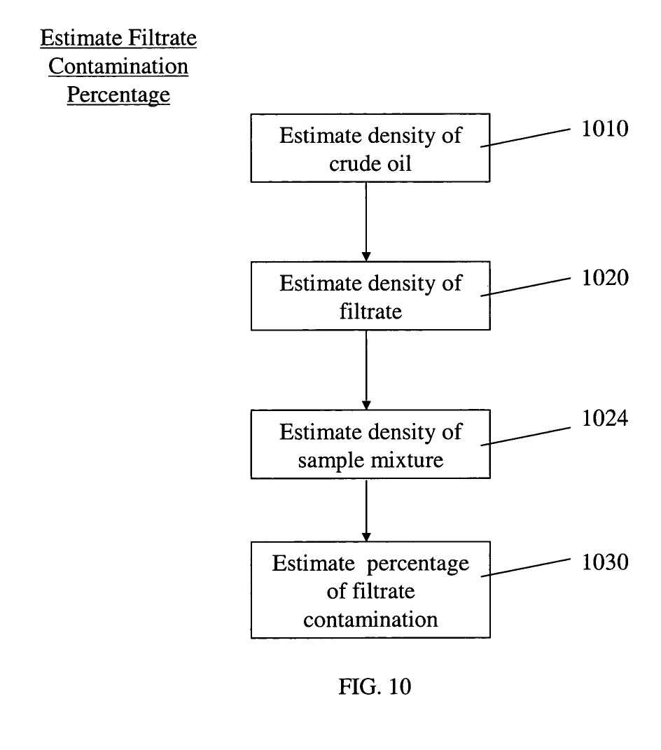

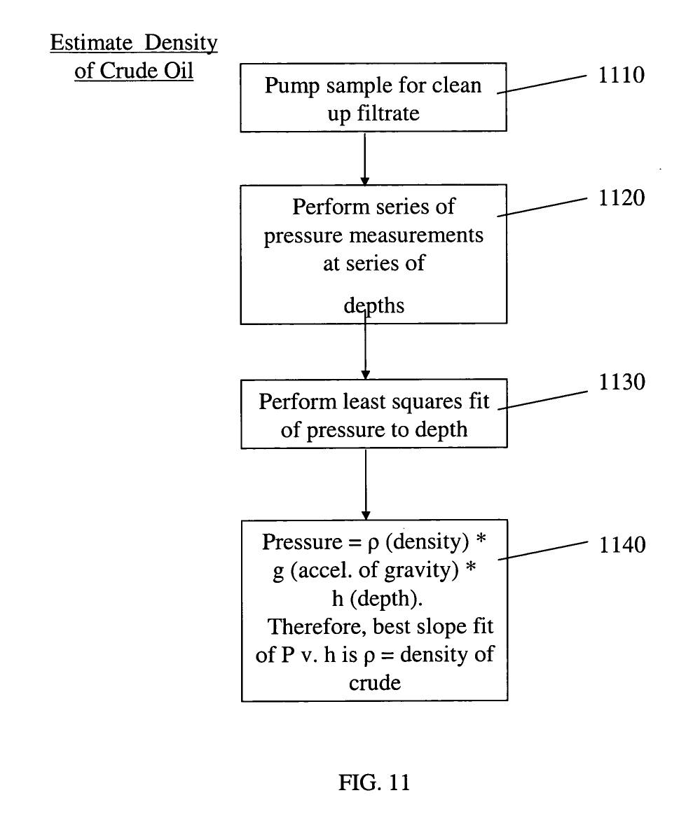

Turning now to FIG. 10, an example of the present invention is shown as a process diagram for obtaining filtrate contamination percentage. As shown in block 1010 the present invention determines the density of crude oil, representative of native formation fluid substantially free of filtrate. As shown in block 1020 the present invention determines the density of filtrate. As shown in block 1024 the present invention determines the density of a sample taken from the formation. The sample comprises a percentage from 0 to 100 percent of formation fluid and 100 to 0 percent filtrate. As shown in block 1030 the present invention obtains a percentage of filtrate contamination for the sample taken from the formation.

Turning now to FIG. 11, block 1010 of FIG. 10 is expanded to illustrate an example of determining the density of crude oil representative of formation fluid or determining the density of the formation fluid itself. As shown in block 1110 the present invention pumps a sample from the formation for a sufficient period of time in order to clean up filtrate from the sample being pumped from the formation, and start pumping mainly crude oil or native formation fluid, substantially absent of the filtrate contamination. As shown in block 1120 the present invention performs a series of high pressure measurements at a series of depths in the well bore or an oil column. As shown in block 1130 the present invention performs a least squares fit of pressure to depth.

As shown in block 1140 the present invention calculates the density of the crude oil based on the relations, P=pgh, where P=pressure, p=density, g=acceleration of gravity and h=depth. The slope of the least square fit of pressure, P versus depth, H is equal to the density, p of crude oil or native formation fluid substantially free of filtrate content. The density of the formation fluid can also be retrieved from processor 411 memory based on legacy or historical data for the formation or representative crude oil which is close to the density of the formation fluid for the formation under investigation. Alternatively, the present invention determines the density using a flexural resonator immersed in formation fluid flowing after a sufficient period of time so that the formation fluid is essentially free of filtrate. Thus, the density of the cleaned up flow is approximately equal to the density of the formation fluid substantially free of filtrate.

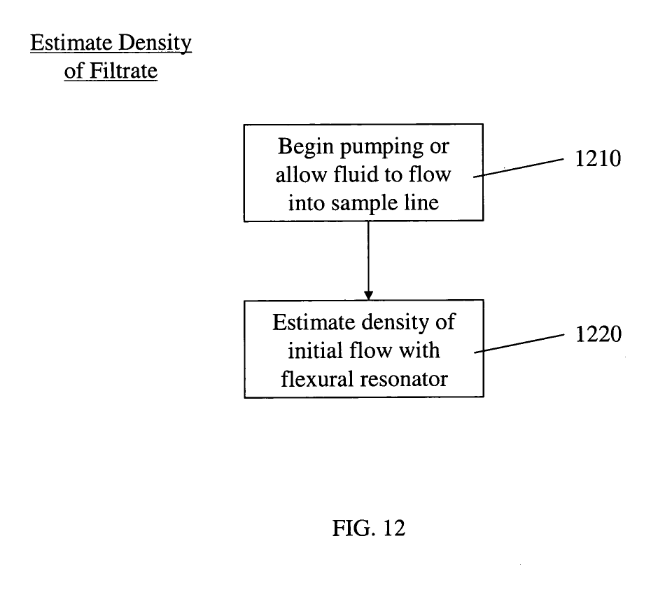

Turning now to FIG. 12, block 1020 is expanded to show an example of the determining the density of filtrate. As shown in block 1210 the present invention begins pumping or allowing fluid to flow into the sample line. As shown in block 1220 the present invention determines the density of initial flow with flexural resonator. The initial flow is substantially made up of filtrate as the sample of fluid being pumped from the formation has not been cleaned up by pumping. Thus, the density of the initial flow is approximately equal to the density of the filtrate.

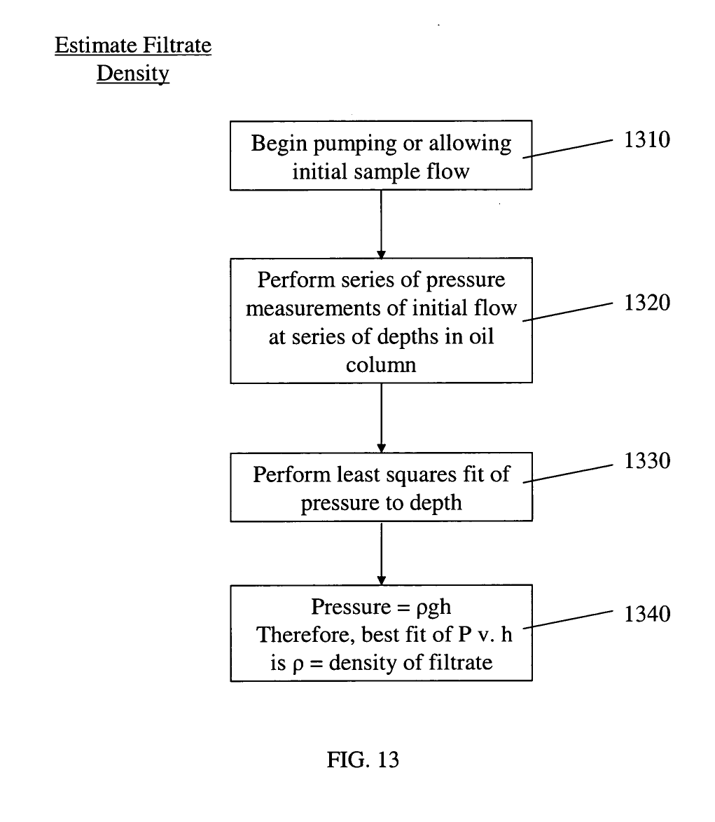

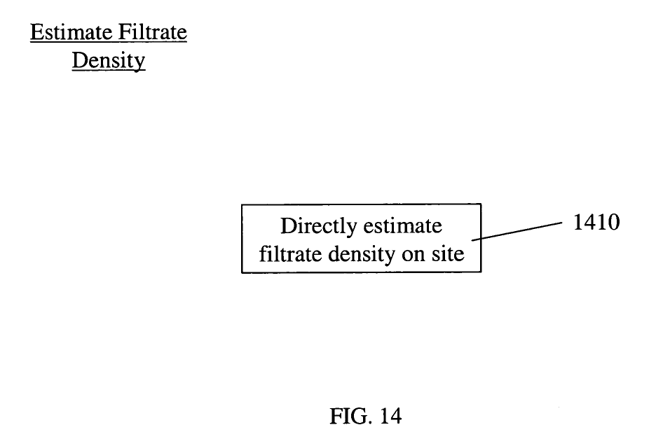

Turning now to FIG. 13, an alternative example of determining filtrate density is shown. As shown in block 1310 the present invention begins pumping or allowing initial sample flow. As shown in block 1320 the present invention performs a series of high precision pressure measurements of initial flow at a series of depths in oil column. As shown in block 1330 the present invention performs least squares fit of pressure to depth. As shown in block 1340 the present invention uses the relation pressure=pgh to perform a best fit of pressure (P) versus depth (h), where the slope, p=density of filtrate is used to determine the density of the filtrate.

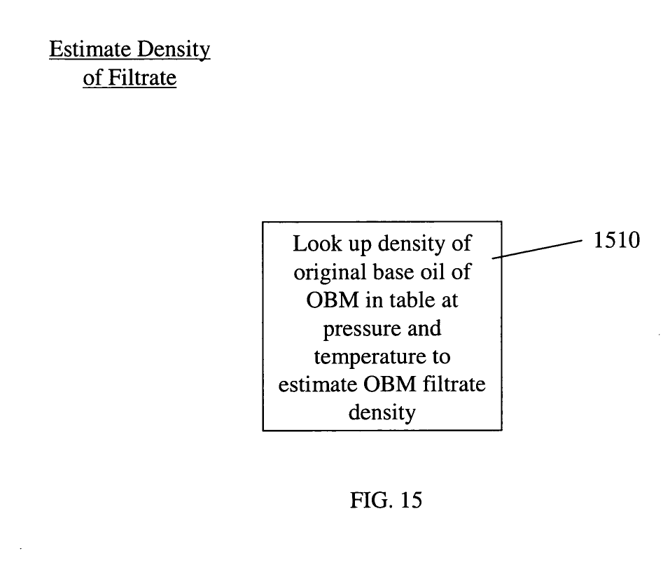

Turning now to FIG. 14, a third alternative example is shown to determine filtrate density. At 1410 the present invention directly measures filtrate density on site at a surface location. Turning now to FIG. 15, a fourth example of the present invention to determine density of filtrate is shown. At 1510 the present invention processor looks up density of the original base oil or other fluid upon which the filtrate is based, in table at pressure and temperature to estimate filtrate density. The table is stored in memory resident in the processor 411.

In another embodiment, the method of the present invention is implemented as a set computer executable of instructions on a computer readable medium, comprising ROM, RAM, CD ROM, Flash or any other computer readable medium, now known or unknown that when executed cause a computer to implement the method of the present invention.

While the foregoing disclosure is directed to the preferred embodiments of the invention various modifications will be apparent to those skilled in the art. It is intended that all variations within the scope of the appended claims be embraced by the foregoing disclosure. Examples of the more important features of the invention have been summarized rather broadly in order that the detailed description thereof that follows may be better understood, and in order that the contributions to the art may be appreciated. There are, of course, additional features of the invention that will be described hereinafter and which will form the subject of the claims appended hereto.

1. A method for determining a percentage of filtrate in a mixture of filtrate and a fluid from a formation downhole comprising:
estimating a density of the fluid in the mixture of filtrate and fluid;
estimating a density of the filtrate in the mixture of filtrate and fluid;
estimating a density of the mixture of filtrate and fluid downhole; and
estimating a percentage of filtrate in the mixture of filtrate and fluid, from the relationship f=(ρ_{M}−ρₒ)/(ρ_{F}−ρₒ) where, ρ_{F} is equal to density of filtrate, ρₒ is equal to the density of the fluid, and ρ_{M} is equal to the density of the mixture of the filtrate and fluid.

2. The method of claim 1, wherein estimating the density of the fluid further comprises:
measuring a pressure of the fluid at a series of depths; and
estimating the density of the fluid from a gradient of measured pressure versus depth.

3. The method of claim 2, wherein the estimating the density of the fluid from a gradient of pressure versus depth further comprises performing a least squares fit of the pressure measurements versus depth to determine a slope for a pressure versus depth relationship, the slope being proportional to the density of the fluid.

4. The method of claim 1, wherein estimating the density of fluid further comprises:
exposing the fluid to a mechanical resonator; and
measuring a response from a mechanical resonator to determine the density of the fluid.

5. The method of claim 1, wherein estimating the density of filtrate further comprises:
exposing an initial flow of the fluid from the formation to a mechanical resonator; and
measuring a response from a mechanical resonator to determine the density of the filtrate.

6. The method of claim 1, wherein estimating the density of filtrate further comprises:
exposing the filtrate to a density measurement device.

7. The method of claim 1, further comprising:
estimating sample cleanup from the percentage of filtrate in the mixture of filtrate and fluid.

8. The method of claim 1, wherein estimating the density of mixture of fluid and filtrate further comprises:
exposing the mixture of fluid and filtrate to a mechanical resonator; and
measuring a response from a mechanical resonator to determine the density of the mixture of fluid and filtrate.

9. The method of claim 1, wherein estimating the density of mixture of fluid and filtrate further comprises:
exposing the mixture of fluid and filtrate to a high precision density measuring device.

10. An apparatus for determining a percentage of filtrate in a mixture of filtrate and a fluid from a formation comprising:
a pressure gauge for measuring a pressure for the formation at a plurality of depths; and
a processor programmed to estimate a density of the fluid in the mixture of filtrate and fluid, a density of the filtrate in the mixture of filtrate and fluid, a density of the mixture of filtrate and fluid and estimate estimating a percentage of filtrate in the mixture of filtrate and fluid, from the relationship f=(ρ_{M}−ρₒ)/(ρ_{F}−ρₒ) where, ρ_{F} is equal to density of filtrate, ρₒ is equal to the density of the fluid, and ρ_{M} is equal to the density of the mixture of the filtrate and fluid.

11. The apparatus of claim 10, wherein the processor estimates the density of the formation fluid further using the pressure measurements at the plurality of depths and estimates the density of the fluid from a gradient of measured pressures versus depths.

12. The apparatus of claim 11, wherein the processor estimates the density of the formation fluid from a gradient of pressure versus depth further by performing a least squares fit of the pressure measurements versus depths to determine a slope for a pressure versus depth relationship, the slope being proportional to the density of the fluid.

13. The apparatus of claim 10, further comprising:
a mechanical resonator exposed to the fluid, wherein the processor measures a response from the mechanical resonator to determine the density of the fluid.

14. The apparatus of claim 10, further comprising:
a mechanical resonator exposed to an initial flow of the fluid from the formation wherein the processor measures a response from the mechanical resonator to determine the density of the filtrate.

15. The apparatus of claim 10, further comprising:
a high precision density measuring device for measuring the density of the filtrate.

16. The apparatus of claim 10, wherein the processor estimates a degree of sample cleanup from the percentage of filtrate in the mixture of filtrate and fluid.

17. The apparatus of claim 10, further comprising:
a mechanical resonator exposed to the mixture of fluid and filtrate, wherein the processor measures a response from the mechanical resonator to determine the density of the mixture of fluid and filtrate.

18. The apparatus of claim 10, further comprising:
a high precision density measuring device that measures the density of the mixture of fluid and filtrate.

19. A system for determining a percentage of filtrate in a mixture of filtrate and a fluid from a formation comprising:
a downhole tool comprising a pressure gauge for measuring a pressure for the formation at a plurality of depths; and
a processor programmed to estimate a density of the fluid in the mixture of filtrate and fluid, a density of the filtrate in the mixture of filtrate and fluid, a density of the mixture of filtrate and fluid and estimate estimating a percentage of filtrate in the mixture of filtrate and fluid, from the relationship f=(ρ_{M}−ρₒ)/(ρ_{F}−ρₒ) where, ρ_{F} is equal to density of filtrate, ρ is equal to the density of the fluid, and ρ_{M} is equal to the density of the mixture of the filtrate and fluid.

20. The system of claim 19, wherein the processor estimates the density of the formation fluid further using the pressure measurements at the plurality of depths and estimates the density of the fluid from a gradient of measured pressures versus depths.

21. The system of claim 20, wherein the processor estimates the density of the formation fluid from a gradient of pressures versus depths by performing a least squares fit of the pressure measurements versus depth to determine a slope for a pressure versus depth relationship, the slope being proportional to the density of the fluid.

22. The system of claim 19, further comprising:
a mechanical resonator exposed to the fluid, wherein the processor measures a response from the mechanical resonator to determine the density of the fluid.

23. The system of claim 19, further comprising:
a mechanical resonator exposed to an initial flow of the fluid from the formation wherein the processor measures a response from the mechanical resonator to determine the density of the filtrate.

24. The system of claim 19, further comprising:
a high precision density measuring device for measuring the density of the filtrate.

25. The system of claim 19, wherein the processor estimate sample cleanup from the percentage of filtrate in the mixture of filtrate and fluid.

26. The system of claim 19, further comprising:
a mechanical resonator exposed to the mixture of fluid and filtrate, wherein the processor measures a response from the mechanical resonator to determine the density of the mixture of fluid and filtrate.

27. The system of claim 19, further comprising:
a high precision density measuring device that measures the density of the mixture of fluid and filtrate.
